(19) United States
(12) Patent Application Publication
(10) Pub. No.: US 2009/0114635 A1
(43) Pub. Date: May 7, 2009

(54) Method for raising chamber temperature and heating apparatus thereof

(76) Inventor: Vincent Wu, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/003,085

(22) Filed: Dec. 20, 2007

(30) Foreign Application Priority Data
Nov. 6, 2007 (TW) 96141839

(51) Int. Cl. F27D 7/04; F27D 11/02

(52) U.S. Cl. 219/400; 219/399

(57) ABSTRACT

A method for raising chamber temperature includes steps of heating enclosed air in the chamber, and infusing the dry air into the chamber to mix with the enclosed air and push out the wet air. A heating apparatus is also disclosed, which will raise the chamber temperature and make the chamber isothermal in a short time so as to have the cost-effective advantage.

### BACKGROUND OF THE INVENTION

1. Field of the Invention

The present invention relates to the method for raising chamber temperature, and more especially, the method can reach a high temperature and isothermal environment in a short time.

2. Background of the Related Art

The process of manufacturing the semiconductor device is followed by a test procedure. Depending on the property of the test semiconductor device, the test apparatus can test the semiconductor device in a high temperature, room temperature or low temperature environment. In general, a test apparatus includes a soak chamber to preheat or precool the semiconductor device, and a test chamber to test the preheated or precooled semiconductor device.

For high temperature testing, the preheating chamber and the test chamber must be set to a specific temperature in advance, so a heater and a fan are configured in the preheating chamber and the test chamber. The heater can raise the chamber temperature and evaporate the water in the chamber, and the fan will drive the vapor out.

However, it consumes time and energy very much to raise the chamber temperature and evaporate the water in the chamber by the simple heater. For example, it takes 90 minutes to increase the chamber temperature from 0° C. to 90° C. and reach an isothermal environment. Hence, it is a target of the present invention to effectively reduce the heating time to reach the isothermal environment quickly.

### SUMMARY OF THE INVENTION

In order to solve the foregoing problems, one object of this invention is to provide a method for raising the chamber temperature. The dry air is infused into the chamber to change the air flow in the chamber, and the wet air is pushed out due to the increased interior pressure, so that the heater can effectively raise the chamber temperature to a specific temperature and quickly reach an isothermal environment under the low time and energy consumption.

According to an embodiment of the present invention, a method is implemented to raise a chamber temperature. The method includes steps of heating an enclosed air in the chamber; and infusing the dry air into the chamber, which will mix with the enclosed air, and pushing the mixed air out of the chamber.

In another embodiment of the present invention, a heating apparatus is applied to a chamber. The heating apparatus includes a heater configured on the chamber to heat an enclosed air in the chamber, and a gas supply apparatus connected to the chamber to supply dry air.

### BRIEF DESCRIPTION OF THE DRAWINGS

FIG. 1 is a diagram illustrating a method for raising chamber temperature in accordance with an embodiment of the present invention;

FIG. 2 is a diagram illustrating a method for raising chamber temperature in accordance with another embodiment of the present invention;

FIG. 3 is a diagram illustrating the test result about raising the chamber temperature in the present invention; and

FIG. 4 is a diagram illustrating a heating apparatus in accordance with an embodiment of the present invention.

### DETAILED DESCRIPTION OF THE INVENTION

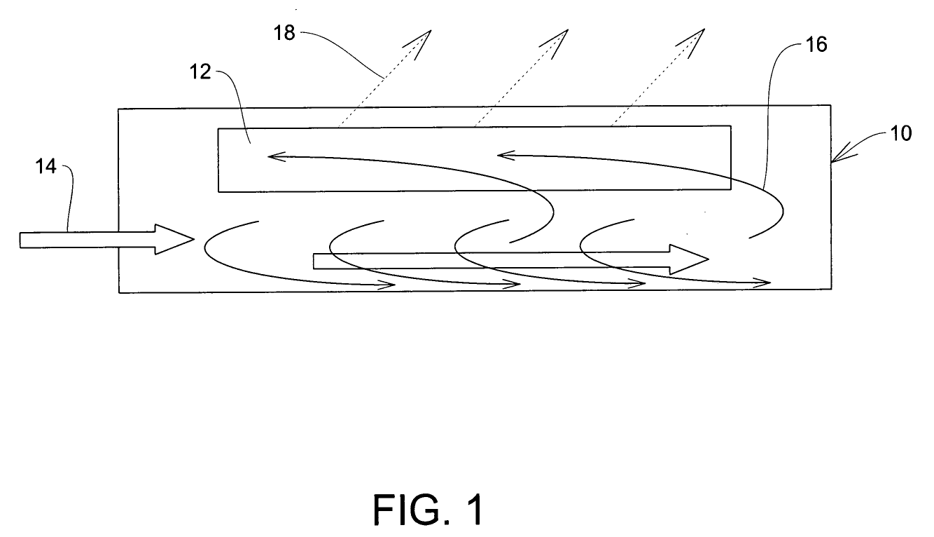

FIG. 1 is a diagram illustrating a method for raising chamber temperature in accordance with an embodiment of the present invention. A heater 12 is configured within a chamber. In the embodiment, the chamber is a test chamber 10, and the heater 12 is used to heat the enclosed air in the test chamber 10. The dry air is infused into the test chamber 10, and the infusion and flow of the dry air are marked as the arrow 14 in FIG. 1. The dry air mixes with the heated enclosed air and changes the enclosed air flow, which is marked as the arrow 16 in FIG. 1. Therefore, the interior pressure in the test chamber 10 is increased to be larger than the outside pressure due to the sustained infusion of the dry air, so that some portion of the air in the test chamber 10 is pushed out as shown as the arrow 18 in FIG. 1. The air, pushed out of the test chamber 10, carries water away.

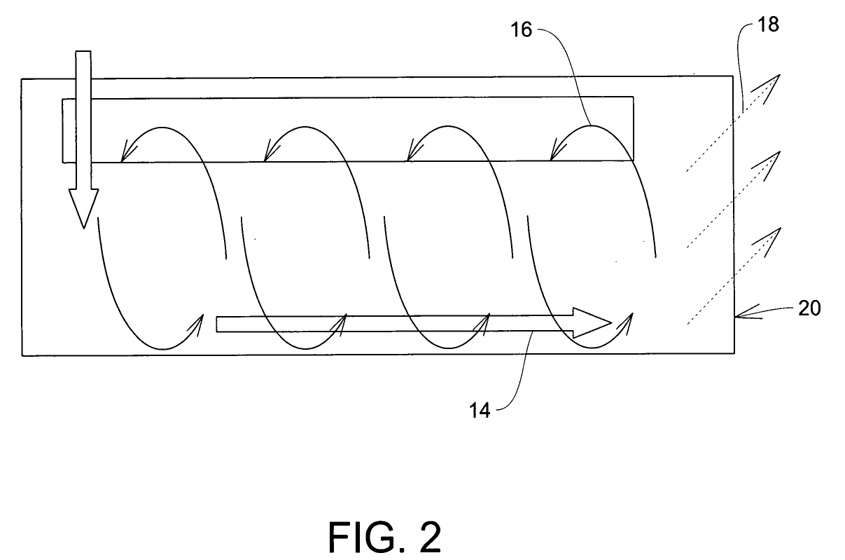

In the foregoing embodiment, the dry air is laterally infused into the test chamber 10 to cause the change of the air flow. In another embodiment, the chamber is a preheating chamber 20. Please refer to FIG. 2, the dry air is downwardly infused into the preheating chamber 20 form the top of the preheating chamber 20, to change the air flow in the preheating chamber 20. As shown in FIG. 2, the arrow 14 illustrates the infusion and flow of the dry air, and the arrow 16 illustrates the flow of the hot air. Accordingly, the mixed air of the enclosed air and the dry air has become wet, and will be pushed out due to the sustained infusion of the dry air, and the exhausted wet air is shown as the arrow 18 in FIG. 2.

Therefore, the moisture in the chamber will be reduced substantially due to exhaustion of the wet air in the chamber, so that the thermal energy produced by the heater can be effectively used to raise the chamber temperature to a specific temperature and reach an isothermal environment in a short time. In another embodiment, an exhauster, such as a fan, is connected with the chamber to hasten exhaustion of the wet air in the chamber.

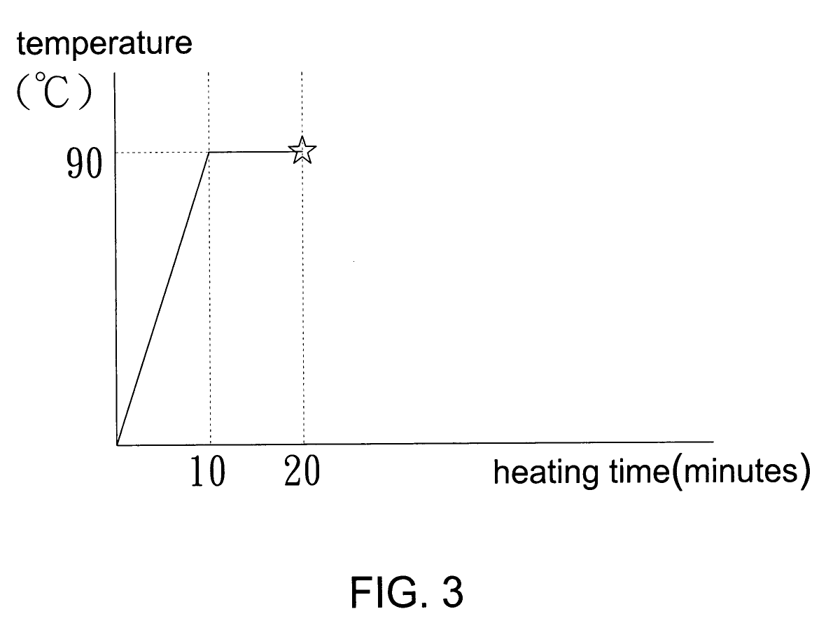

FIG. 3 is a diagram illustrating the test result about raising the chamber temperature of the present invention. As shown in FIG. 3, because the infusion of the dry air, the chamber temperature is increased from 0° C. to 90° C. during the heating time, about 10 minutes, by the heater and kept at 90° C. for a period, about 10 minutes to reach the isothermal environment, and then the heater stops operating. Other test result of the present invention, for example, the chamber temperature is increased from −10° C. to 90° C. and reaches the isothermal environment in the heating time, about 20 minutes. In another example, the chamber temperature is increased from −30° C. to 90° C. and reaches the isothermal environment about 23 minutes. By comparing the conventional method with the present invention, the conventional method needs about 90 minutes to increase the chamber temperature from 0° C. to 90° C., so the present invention has the advantages of decreasing the heating time and reducing the cost.

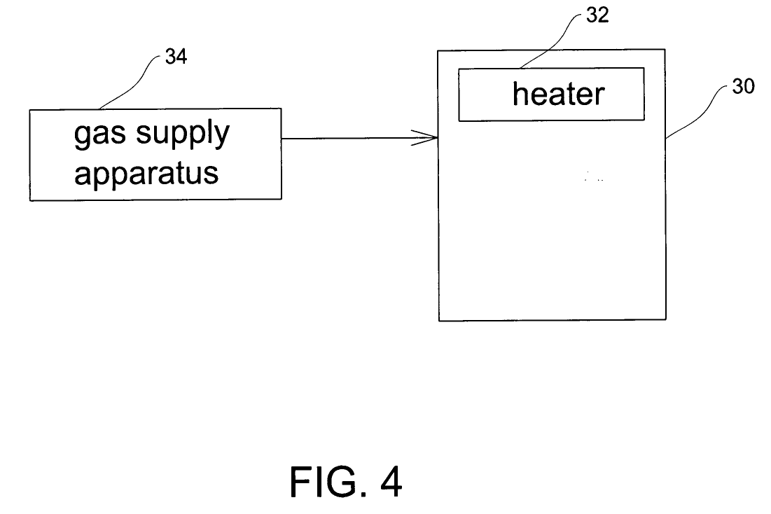

FIG. 4 is a diagram illustrating a heating apparatus in accordance with an embodiment of the present invention. The heating apparatus is applied to the chamber 30 for hastening the performance of raising the chamber temperature to a specific temperature. The heating apparatus includes a heater 32 and a gas supply apparatus 34. The heater 32 is configured on the upper position of the interior of the chamber 30 to heat the whole air enclosed in the chamber 30, and the gas supply apparatus 34 is connected with the chamber 30 to supply the dry air into the chamber 30.

Continuously, if the chamber is a test chamber, the gas supply apparatus infuses the dry air laterally into the chamber, and if the chamber is a preheating chamber, the gas supply apparatus infuses the dry air downwardly into the chamber form the top of the chamber. No matter what the direction of the dry air infused, the infusion of the dry air will change the air flow of the chamber and increase the interior pressure of the chamber to push out the air which carries water. In another embodiment, an exhauster, such as a fan, is connected with the chamber to hasten the exhaustion of the air enclosed in the chamber.

To sum up, in the present invention, the dry air is infused into the chamber to change the air flow of the chamber, and some portion of the air enclosed in the chamber is pushed out due to the increase of the interior pressure of the chamber, and so that the heater can raise the chamber temperature to a preset temperature and then to obtain an isothermal environment in a short time to have the advantage of reducing the time and cost.

Although the present invention has been explained in relation to its preferred embodiment, it is to be understood that other modifications and variation can be made without departing the spirit and scope of the invention as hereafter claimed.

What is claimed is:

1. A method for raising a chamber temperature, comprising:
heating an enclosed air in a chamber; and
infusing dry air into said chamber to mix with said enclosed air to form a mixed air; and
pushing said mixed air out of said chamber.

2. The method for raising chamber temperature according to claim 1, further comprising an exhausting step to hasten exhaustion of said mixed air.

3. The method for raising chamber temperature according to claim 1, wherein said mixed air is wet.

4. The method for raising chamber temperature according to claim 1, wherein said chamber is a test chamber or a preheating chamber.

5. A heating apparatus, applied to a chamber, comprising:
a heater configured on said chamber to heat an enclosed air in said chamber; and
a gas supply apparatus connected with said chamber to supply a dry air.

6. The heating apparatus according to claim 5, further comprising an exhauster connected with said chamber to push out an mixed air in said chamber, wherein said mixed air is the mixture of said enclosed air and said dry air.

7. The heating apparatus according to claim 6, wherein said mixed air is wet.

8. The heating apparatus according to claim 6, wherein said exhauster is a fan.

9. The heating apparatus according to claim 6, wherein said chamber is a test chamber or a preheating chamber.
